(19) United States
(12) Patent Application Publication
(10) Pub. No.: US 2006/0132964 A1
(43) Pub. Date: Jun. 22, 2006

(54) Power reduction scheme for use with a disc drive magazine

(75) Inventors: Kenneth Dean Lau, Longmont, CO (US); Matthiew Thomas Starr, Lafyette, CO (US)

Correspondence Address: WALL MARJAMA & BILINSKI, 101 SOUTH SALINA STREET, SUITE 400, SYRACUSE, NY, 13202, US

(73) Assignee: Spectra Logic Corporation, Boulder, CO (US)

(21) Appl. No.: 11/352,766

(22) Filed: Feb. 13, 2006

Related U.S. Application Data
(63) Continuation-in-part of application No. 10/605,222, filed on Sep. 16, 2003.

(51) Int. Cl. G11B 15/68

(52) U.S. Cl. 360/92

(57) ABSTRACT

Disclosed is an apparatus for a data storage library comprising at least one of a plurality of docking stations adapted to receive a disc drive magazine wherein the magazine comprises a plurality of disc drives. The docking station is adapted to receive the disc drive magazine via a loading device capable of automatically engaging the magazine with the at least one docking station to establish a communication link between the magazine and the at least one docking station. A retaining device is adapted to retain the magazine when engaged with the at least one docking station and when the magazine is in at least an active state. The library comprises at least one interface that is adapted to establish a communication link capable of transferring data between at least one data consumer and the library. The disc drive magazine when linked with the at least one docking station is capable of storing data received by the at least one data consumer. The magazine is capable of changing from a fully active state to at least one quiescent state when storage operations as performed by the magazine requires less than a fully active magazine.

### CROSS-REFERENCE-TO RELATED APPLICATIONS

This application is a continuation in part of U.S. Ser. No. 10/605,222, filed Sep. 16, 2003, the entire disclosure of which is incorporated herein by reference.

### FIELD OF THE-INVENTION

The present invention relates to an apparatus for reducing power consumption of at least one disc drive magazine storage device comprised by a data storage library.

### BACKGROUND

Data storage libraries, such as tape libraries or disc drive magazine based libraries for example, are adapted to store and retrieve large amounts of data for data manipulation and archiving purposes. Aside from general energy consuming components comprised by data storage libraries such as fans, robotic systems, monitors, etc., storage related components, for example disc drive magazines, can consume a large share of the overall energy used by a storage library.

One such storage related component is a disc drive magazine. A disc drive magazine can comprise two or more of disc drives and is capable of functioning as a mobile storage media element. A disc drive magazine is often made to operate when coupled with a docking station. The docking station, in general, provides both power and a communications link between the disc drive magazine and a user of data, such as a host. When coupled, power is supplied to the disc drive magazine, causing the disc drives therein to become fully operational for storing and retrieving data. When fully operational, the disc drives comprised by the magazine not only substantially consume maximum power, but sustain continuous wear and tear.

In an effort to provide an improvement in disc drive longevity and reduce power consumption by a disc drive magazine, an apparatus is described herein. It is to innovations related to this subject matter that the claimed invention is generally directed.

### SUMMARY OF THE INVENTION

The present invention relates generally to an apparatus for reducing power consumption of at least one disc drive magazine storage device comprised by a data storage library.

One embodiment of the present invention can therefore comprise a data storage library comprising: at least one of a plurality of docking stations adapted to receive a disc drive magazine wherein the magazine comprises a plurality of disc drives; a loading device adapted to automatically engage the magazine with the at least one docking station to establish a communication link between the magazine and the at least one docking station; a retaining device adapted to retain the magazine when engaged with the at least one docking station and when the magazine is in at least an active state; at least one interface adapted to establish a communication link capable of transferring data between at least one data consumer and the library; the magazine capable of storing data received by the at least one data consumer when linked with the at least one docking station; the magazine capable of changing from a fully active state to at least one quiescent state when storage operations performed by the magazine requires less than a fully active magazine.

Another embodiment of the present invention can therefore comprise a data storage library comprising: at least one of a plurality of docking stations adapted to receive a mobile disc drive magazine wherein the magazine comprises a plurality of disc drives; a loading device adapted to automatically pull the magazine into the at least one docking station in an engaging relationship to establish a communication link between the magazine and the at least one docking station and wherein the loading device is also adapted to automatically eject the magazine in a disengaged relationship with the at least one docking station when the magazine is in a substantially inactive state; an interface adapted to establish a communication pathway capable of transferring data between at least one data consumer and the library; the magazine capable of storing data received by the at least one data consumer when linked with the at least one docking station; the magazine capable of changing from a fully active state to at least one quiescent state when storage operations performed by the magazine requires less than a fully active magazine.

Yet another embodiment of the present invention can therefore comprise a system for saving power in a data storage library comprising: means for automatically drawing a mobile disc drive magazine towards a connecting surface of one of a plurality of docking stations comprised by the library; means for engaging the magazine with the docking station in an operatively linked state capable of storing data; means for establishing a communication pathway capable of transferring data between a data consumer and the library; means for retaining the magazine and the docking station in the operatively linked state while the magazine is actively engaged in storage related operations; means for changing the magazine from an active state to a quiescent state when the storage operations requires less than a fully active magazine.

Yet another embodiment of the present invention can therefore comprise a data storage library comprising: at least one of a plurality of docking stations adapted to receive a disc drive magazine to establish a communication link between the magazine and the at least one docking station wherein the magazine comprises a plurality of disc drives; a retaining device adapted to retain the magazine when engaged with the at least one docking station and when the magazine is in at least an active state; at least one interface adapted to establish a communication link capable of transferring data between at least one data consumer and the library; the magazine capable of storing data received by the at least one data consumer when linked with the at least one docking station; the magazine capable of changing from a fully active state to at least one quiescent state when storage operations performed by the magazine requires less than a fully active magazine.

### BRIEF-DESCRIPTION OF THE DRAWINGS

FIG. 1 is a block diagram of a data storage arrangement constructed in accordance with an embodiment of the present invention.

FIG. 2 shows an embodiment of a disc drive magazine and docking station consistent with some embodiments of the present invention.

FIGS. 3A-3C are illustrations of a mobile disc drive magazine inserted in a docking station consisted with some embodiments of the present invention.

FIG. 4 is a block diagram illustrating one quiescent state of a mobile disc drive magazine when engaged and communicatively linked with a docking station consistent with some embodiments of the present invention.

FIG. 5 is a block diagram illustrating an embodiment for controlling active and quiescent states for mobile disc drive magazines when operatively linked consistent with embodiments for the present invention.

FIG. 6A shows an exemplary method to practice some embodiments of the present invention.

FIG. 6B shows an exemplary embodiment of a continuity arrangement for confirming alignment of a docking station and mobile disc drive magazine.

FIG. 7 shows an alternative method to practice some embodiments of the present invention.

FIG. 8 shows a front and side view of an unenclosed RXT T950 data storage library wherein some embodiments of the present invention can be practiced.

FIG. 9 shows a rear and side view of an unenclosed RXT T950 data storage library wherein some embodiments of the present invention can be practiced.

FIG. 10 shows an interior section view of the front half of an RXT T950 data storage library wherein some embodiments of the present invention can be practiced.

FIG. 11 shows an interior section view of the rear half of an RXT T950 data storage library wherein some embodiments of the present invention can be practiced.

FIG. 12 shows a front and side view of an enclosure of an RXT T950 data storage library wherein some embodiments of the present invention can be practiced.

FIGS. 13A-13D show interior features of the loading mechanism for an RXT docking station consistent with some embodiments of the present invention.

FIGS. 13E-F show an RXT disc drive magazine inserting in an RXT docking station consistent with some embodiments of the present invention.

### DETAILED DESCRIPTION

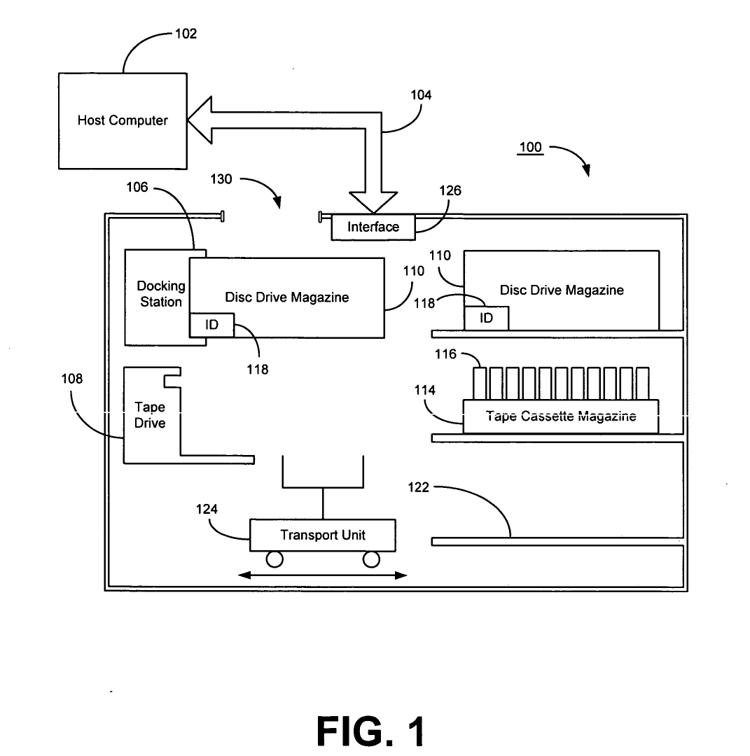

Referring to the drawings in general, and more specifically to FIG. 1, shown therein is a block diagram of a data storage arrangement constructed in accordance with an embodiment of the present invention. In what follows, similar or identical structure is identified using identical callouts.

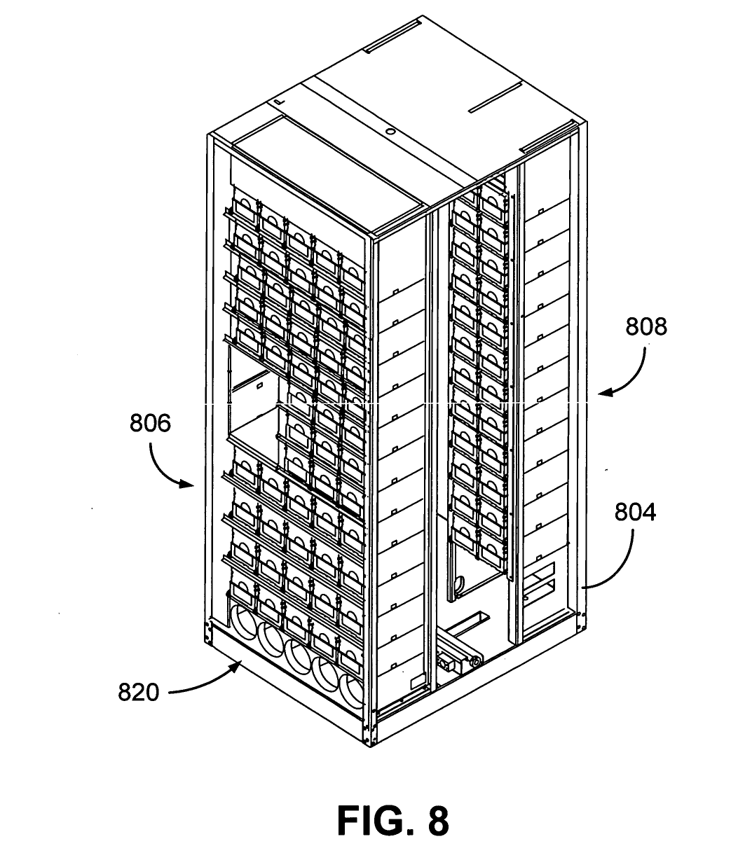

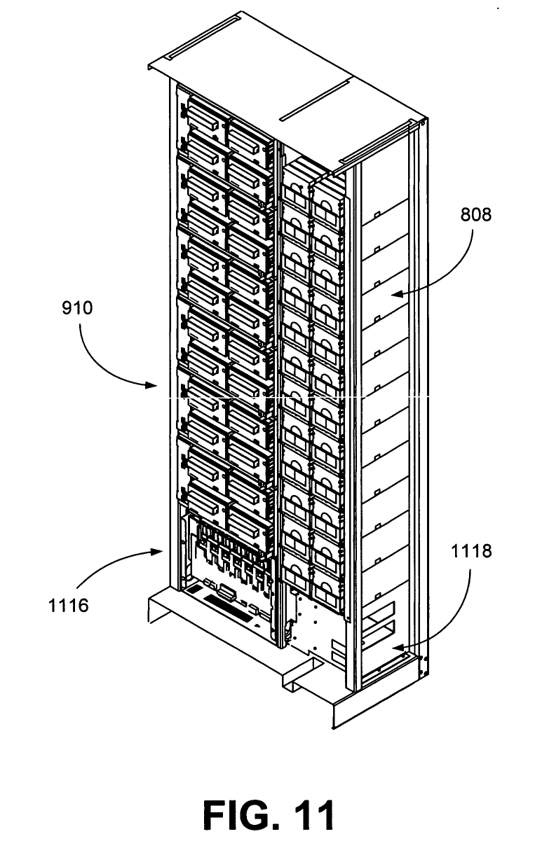

The data storage arrangement illustrated in FIG. 1 can comprise a host computer 102 in communication over communication path 104 with a data storage library 100. The library 100 illustratively comprises a docking station 106, a tape drive 108, a transport unit 124, and various storage media and support systems. A detailed description of an exemplary library is given in connection with FIGS. 8-13F. The host computer 102 is one embodiment of a data consumer which can further include a personal computer, a main frame computer, a server, or any other computer system linked to the storage library 100, to name a few examples. Other embodiments of a data consumer can be another library system or a streaming output device, such as a video server, to name two more examples. The communication path 104, at a minimum, needs only to facilitate communication between the host computer 102 and the storage library 100. The means for communication can be accomplished by a dedicated pathway (such as a SCSI [Small Computer Systems Interface] cabled connection) or, in an alternative embodiment, a pathway over a network (such as a LAN, WAN, or other communication architecture), for example. Furthermore, the communication path 104 can be in the form of a wire line pathway, wireless, or a combination thereof, for example. In the illustrative embodiment of FIG. 1, the data storage library 100 comprises an interface 126 adapted to establish a communication link for data to be transferred between the host computer 102 and the data storage library 100. One skilled in the art will appreciate that the interface 126 can be disposed in the library 100 at an interception point for the host computer 102, or on each docking station 106, or on each tape drive 108, or another suitable location either inside or external to the library 100. The interface is adapted to translate from one communication mechanism, i.e. from the host computer 102, to another communication mechanism, in this case the library 100 generally or a specific library component, such as the docking station 106, within the library 100. The storage library 100 is capable of retrieving and storing data for the host 102 via at least one of a plurality of docking stations 106 (in this example only one is shown) when communicatively linked with a disc drive magazine 110, as shown, or via at least one tape drive 108 when cooperating with a tape cassette 116. The storage library 100 further comprises a transport unit 124 and shelf system 122, wherein the transport unit 124 is capable of transporting a disc drive magazine 110 from a shelf system 122 to a docking station 106 or a tape cassette magazine 114 from the shelf system 122 to a tape drive 108. In this embodiment, the disc drive magazines 110 and tape cassette magazine 114 (capable of holding a plurality of tape cassettes 116) have substantially identical footprints to facilitate commonality for transporting within the data storage library 100 by the transport unit 124. A disc drive magazine 110 or tape cassette magazine 114 can be moved in and out of the data storage library 100 via an entry/exit port 130. An identifier, such as a bar code for example, can optionally be associated with each disc drive magazine 110 or tape cassette magazine 114 and can be used to identify the disc drive magazine 110 or tape cassette magazine 114 if archived in a remote location for example, such as an media pack storage vault for example.

In another embodiment of the present invention, the docking station 106, which is used to cooperate or link with a disc drive, or other random access storage media, is dimensionally substantially identical to a full height LTO, SAIT or DLT tape cassette drive. Consequently, either a tape drive 108 or a docking station 106 is capable of being interchangeably mounted in one of a plurality of drive bay assemblies (not shown) of the library 100, allowing the data storage library 100 an additional degree of flexibility.

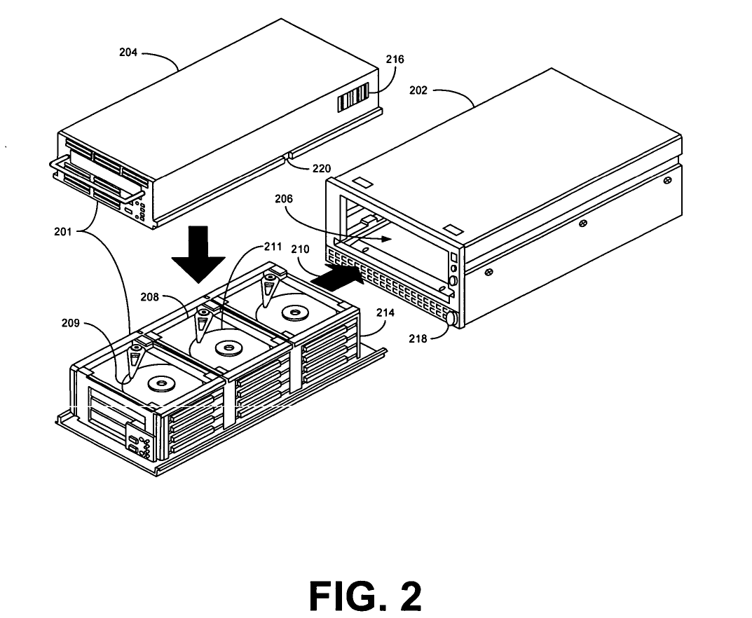

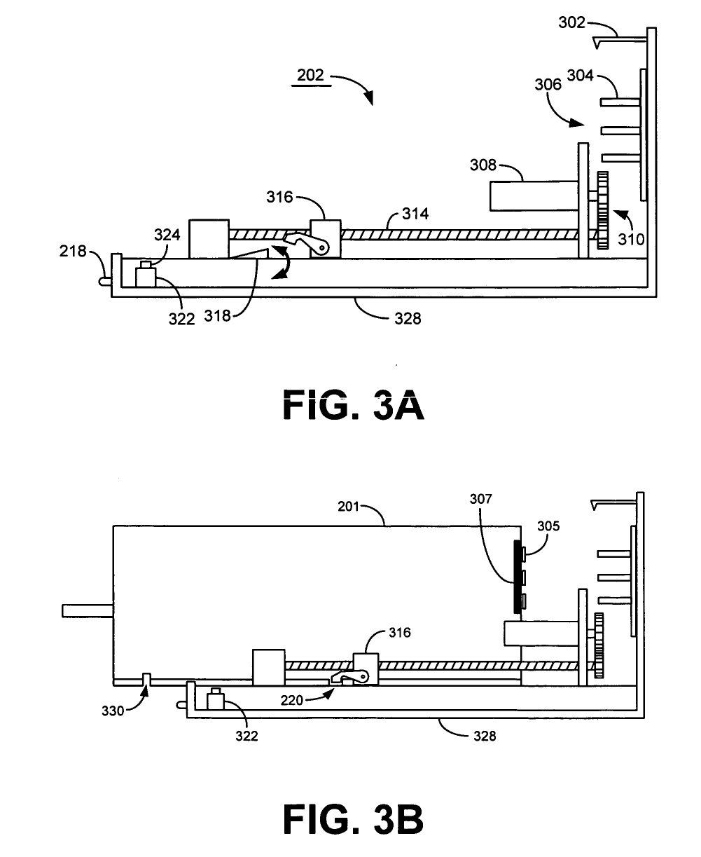

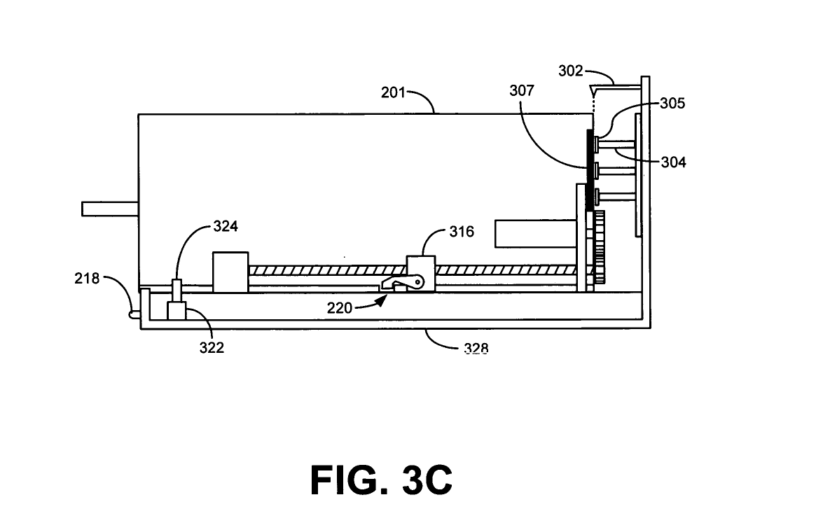

FIG. 2 shows an embodiment of a disc drive magazine 201 (similar to magazine 110 in FIG. 1) and docking station 202 (similar to docking station 106 in FIG. 1) consistent with some embodiments of the present invention. More specifically, shown herein is an RXT disc drive magazine and RXT docking station commercially available from Spectra Logic Corporation of Boulder, Colo. Herein, a plurality of disc drives 208 are shown substantially encased by an enclosure 204 generally comprising the mobile disc drive magazine 201. Disposed on the enclosure 204 is a bar code identifier 216 adapted to identify the disc drive magazine 201, which has utility if the disc drive magazine 201 is archived in a media pack storage vault, for example. A conventional magnetic disc drive 208 is only one embodiment of a random access storage device capable of being used in a mobile random access memory magazine such as the disc drive magazine 201 according to the present invention, which, in further embodiments, can include flash memory and optical memory, just to name a few. The mobile disc drive magazine 201 is adapted to be received by an opening 206 in the docking station 202 as shown by the arrow 210. The engaging surface 214 of the mobile disc drive magazine 201 comprises electrical contacts (shown in connection with FIG. 3C) capable of contacting complementary electrical contacts (shown in connection with FIG. 3C) on the engaging surface (shown in connection with FIG. 3C) of the docking station 202. In one embodiment, a loading device (not shown) is disposed in the docking station 202 and is adapted to automatically pull the mobile disc drive magazine 201 by a notch 220 associated with the enclosure 204 to engage the magazine 201 with the docking station 202 in electrical contact, thereby establishing a communication link. The loading device can also be adapted to automatically eject the mobile disc drive magazine 201, effectively disengaging, and unlinking, the docking station 202 with the mobile disc drive magazine 210. In alternative embodiments, a manually operated eject switch 218 could be disposed on the docking station 202 as shown herein or on a control panel (not shown), for example, accessible by a user on the data storage library 100. When the mobile disc drive magazine 201 is operatively linked with the docking station 202, both power and transmission of data can occur between the docking station 202 and the mobile disc drive magazine 201. The docking station 202 is capable of being connected with a host computer, such as the host computer 102, or other storage device/s, such as another data storage library for example, by a coupling means, such as wires, plugs-in, wireless transmission (e.g., IR, RF) or any combination or equivalence thereof. In one embodiment, by linking the docking station 202 with the data storage library 100, a mobile disc drive magazine 201 is effectively in a cooperatively linked state with the other storage devices comprised by the storage library 100.

FIGS. 3A-3C are illustrations of a mobile disc drive magazine 201 inserted in a docking station 202 consistent with some embodiments of the present invention. FIG. 3A is a side view (simplified) cut-away illustration of the docking station 202 and, more specifically, the loading device consistent with some embodiments of the present invention. Herein, the components include a base 328 for supporting the loading device which comprises a lead screw 314 driven by a motor 308 and gear system 310. The lead screw 314 serves to move a latch 316 that is capable of mechanically latching onto the notch 220 located in the base of the mobile disc drive magazine 201, as shown in FIG. 3B. The latch 316 cooperates with a cam ramp 318 that, when depressed, forces the latch 316 to rotate in an engaging position with the notch 220 of magazine 201.

As shown in FIG. 3C, the mobile disc drive magazine 201 is pulled, or drawn, in contact with the docking station 202 (in this case to the back 306). The docking 202 station also comprises a retaining device 322 that further comprises a bolt 324 sized for insertion into a mating hole 330 in the base of the mobile disc drive magazine 201. The bolt 324 is adapted to lock the magazine 324 in place when deployed in the inserted position. The retaining 322 device can be deployed in response to a signal generated by a sensor, such as an optical switch 302 or other sensing device, indicating the mobile disc drive magazine 201 and the docking station 202 are engaged in an operable position. The retaining device 322 can further be controlled to remain in a deployed state (locking the mobile disc drive magazine 201 in the engaging position with the docking station 202) while the mobile disc drive magazine 201 and the docking station 202 are in at least an active state. The active state is when data is being transmitted between the mobile disc drive magazine 201 and the docking station 202 or when the mobile disc drive magazine 201 is simply in an “on state”, perhaps storing of refurbishing data, to name two examples. In one embodiment, the eject switch 218 is adapted to cause the mobile disc drive magazine 201 to be ejected from the docking station 202 in reverse of the way the magazine 201 is pulled into the docking station 202. An activity sensor (not shown) capable of monitoring when the mobile disc drive magazine 201 is engaged and active with the docking station 202, such as a simple voltage monitor capable of sampling for power use across the linking contacts 304 and 305 for example, can cooperate with the retaining device 322 and the loading device to determine readiness for magazine 201 ejection. The eject switch 218 is adapted to cause the mobile disc drive magazine 201 to be ejected from the docking station 202 only when the activity sensor (not shown) senses substantial inactivity with the disc drive magazine 201. Hence, in one embodiment, a sensing system can comprise the optical switch 302 to deploy the retaining device 322 and the activity sensor (not shown) to keep the mobile disc drive magazine 201 in a retained state until the magazine 201 is substantially inactive, regardless of any call to eject from the ejection switch 218 for example. Though a retaining device 322 is described in this embodiment as a bolt 324 adapted to lock a magazine 324, a retaining device is intended to function to retain the magazine 324 in contact with the docking station 202 and therefore can assume other embodiments such as magnetic latches, gears or friction fittings generated by electrical plugs and sockets, just to name a few.

FIG. 3C also shows an embodiment featuring flexible contact pins 304 disposed on the back surface of the docking station base 328 engaged with contact pads 305 comprised by a magazine-drive connector 307 disposed on the mating surface 214 of the mobile disc drive magazine 201. Flexible contact pins 304 and contact pads 305 advantageously provide for large engaging and disengaging cycles between a mobile disc drive magazine 201 and a docking station 202 while avoiding wear of the contacts. Alignment pads and pins can also be used to ensure adequate alignment between the mobile disc drive magazine 201 and the docking station 202, (see U.S. Ser. No. 11/019,911 filed Dec. 22, 2004, incorporated herein by reference).

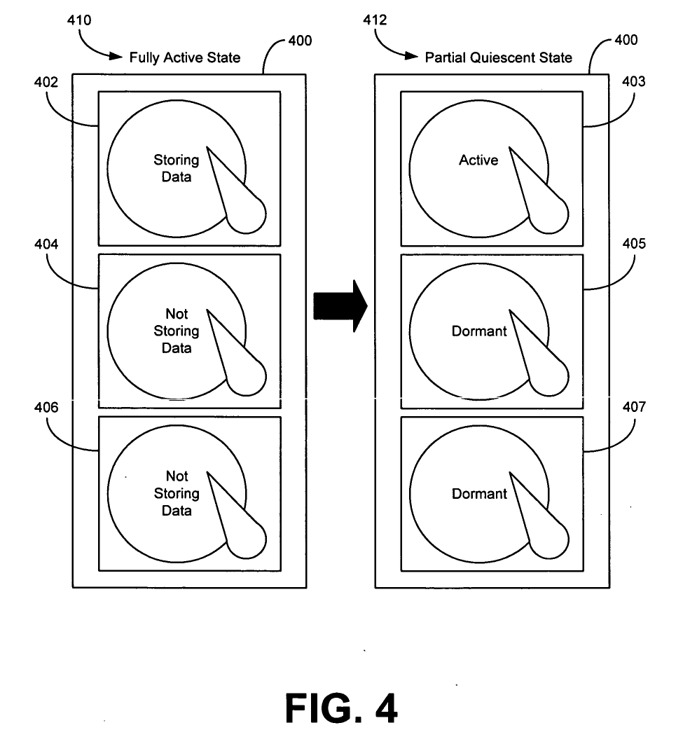

FIG. 4 is a block diagram illustrating one quiescent state of a mobile disc drive magazine 400 when engaged and communicatively linked with a docking station (not shown) consistent with some embodiments of the present invention. Herein, the mobile disc drive magazine 400 is capable of changing from a fully active state 410 to at least one quiescent state 412 (or one level of quiescence) when storage operations performed by the magazine 400 requires less than full activity. The fully active mobile disc drive magazine 410 comprises a first disc drive 402 shown actively storing data, a second disc drive 404 in a fully powered state yet not performing any storage operations, and a third disc drive 406 in a fully powered state yet not performing any storage operations. Power provided to the mobile disc drive magazine 400, such as by the data storage library 100, is minimized by changing to the partial quiescent state 412 (or one level of quiescence) wherein the first disc drive remains active 403 and power provided to the second disc drive 405 and third disc drive 407 is reduced, thereby changing the second and third disc drives 405 and 407 to a dormant state in an alternative embodiment, the mobile disc drive magazine 201 can be either in a fully active state or a fully dormant state. This may be advantageous in the event of RAID (Redundant Array of Independent disc [drives]) data striping across all of the disc drives 208 comprised by the mobile disc drive magazine 201. When the mobile disc drive magazine 201 is actively storing RAID data, all disc drives 201 may be active and when finished the entire magazine 201 may be put into a dormant state. A dormant state can be initiated by a command from a controller, for example, upon indication that a specific data package is completely stored or after a defined amount of time wherein there is no occurrence of storage related activity, just to name two examples.

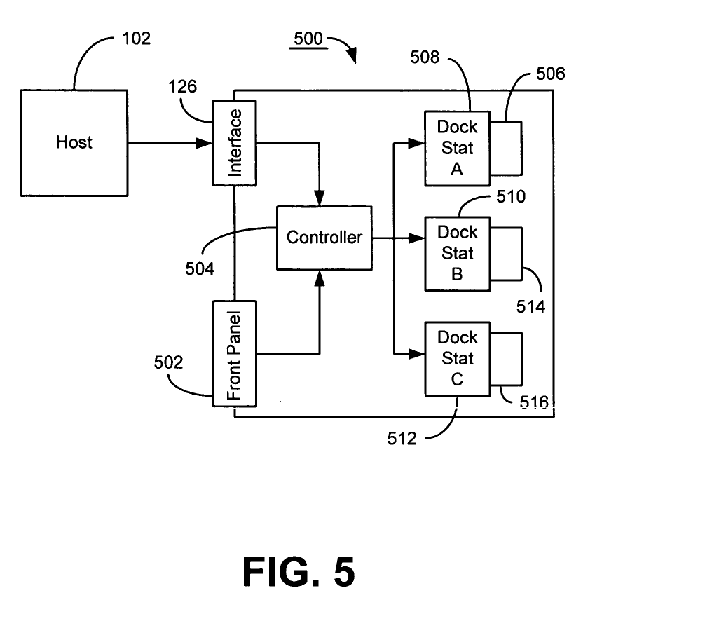

FIG. 5 is a block diagram illustrating an embodiment for controlling active and quiescent states for mobile disc drive magazines 506 when operatively linked consistent with embodiments for the present invention. Herein, an interface 126 functionally interposed between the library and host computer 102 is adapted to receive communications from the host computer 102. In the event of a request for storage operations, the interface 126 can transmit the request to a controller 504 capable of controlling the state of activity for the mobile disc drive magazines 506 linked with docking stations A 508, B 510 and C 512. For example, should the host 102 choose to store data at docking station A 508, the controller 504 can change the state of the mobile disc drive magazine 506 linked with docking station A 508 from a dormant state, wherein the disc drives 208 comprised by docking station A 508 are all substantially “turned off”, to a fully active state. The disc drive magazine 506 linked with docking station A 508 can store the data received by the host 102 which could include storing data to one disc drive 208 or in an alternative embodiment, data can be stored redundantly on the other disc drives 208 comprised by the magazine 506 in a RAID format. The mobile disc drive magazines 514 and 516 linked with docking stations B 510 and C 512, respectively, can remain in a dormant state unless the controller 504 turns them to an active state for storage operations to reserve power usage by the library 500.

In another embodiment of the present invention, one or all of the mobile disc drive magazines 506, 514 and 516 can be made active from a quiescent state via the front panel 502 of the library 500. The front panel 502 can be a touch screen for a user or operator to control the library manually or alternatively, there can be an algorithm that could initiate commands to “turn on” the mobile disc drive magazines 506, 514 and 516 to an active state from a dormant state. Turning the disc drive magazines on from the front panel 502 may be in response to a data refresh command or data transfer command from the library 500 to another library for data back-up purposes, just to name two examples. In yet another embodiment, each docking station A 508, B 510 and C 512 may comprise an interface and controller capable of controlling the state of activity of the respective linked magazines 506, 514 and 516. A further embodiment can include a means for each docking station A 508, B 510 and C 512 to communicate directly to a user of data, such as via an Ethernet connection or a Fibernet connection for example.

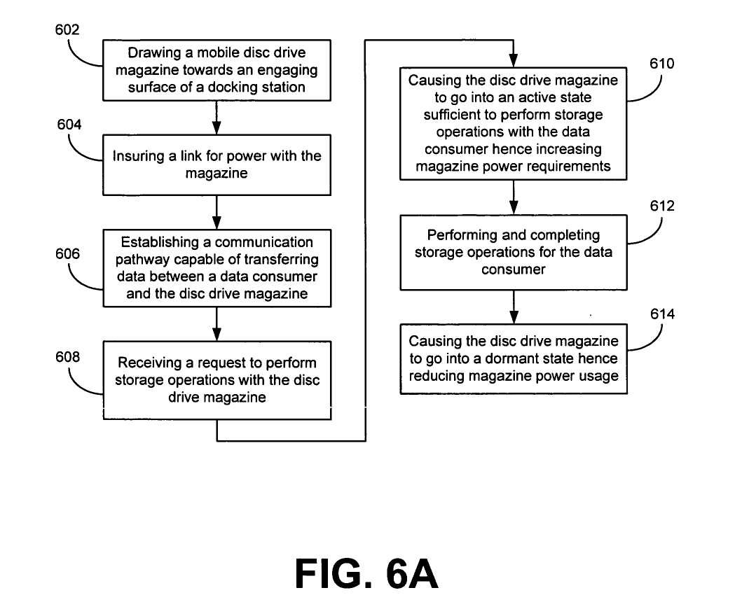

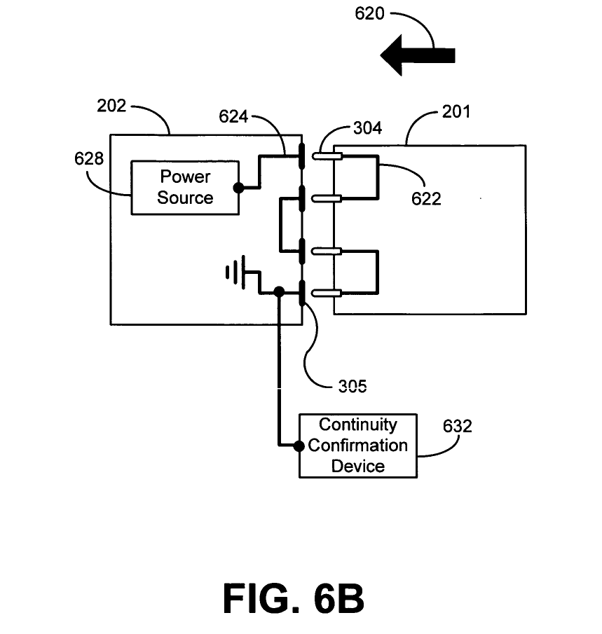

FIG. 6A shows an exemplary method to practice some embodiments of the present invention. As shown in step 602, a mobile disc drive magazine, such as the magazine 201 from FIG. 3A-3C, can be drawn into engagement with the a docking station, such as the docking station 202, capable of forming a communication link with the docking station 202. A means for ensuring a link for power and communication between the mobile disc drive magazine 201 and the docking station 202, as shown in step 604, could be accomplished with continuity test contacts and system, for example. Continuity test contacts and system can also be used as an alignment tool when two or more contact points establish a closed circuit. In one exemplary configuration shown in FIG. 6B, a continuity confirmation device 632 can indicate when a closed circuit is formed between circuit components 622 associated with the magazine 201 and the circuit components 624 associated with the docking station 202 upon engagement 620 of the pins 304 and pads 305 by sensing power from the power source 628 associated with the docking station. As one skilled in the art will appreciate, a number of different continuity configurations can be devised while still maintaining substantially the same functionality without departing from the scope and spirit of the present invention. Step 606 shows a step for establishing a communication and power link between the mobile disc drive magazine 201 and a consumer of data, such as the docking station 202. A means to establish a communications pathway can be accomplished with aligned electrical contact points with verification via a simple successful communication task between the magazine 201 and the docking station 200, such as a communication “ping” for example. Once linked, the mobile disc drive magazine 201 can be controlled to remain in a substantially un-powered, or dormant, state. In one embodiment, the mobile disc drive magazine 201 may comprise a controller (such as the controller 504 in FIG. 5) and interface (such as the interface 126 in FIG. 5) which may be kept in a powered state to maintain low level communication via the docking station 202. Upon receiving a request to perform storage operations, as shown in step 608, the disc drive magazine 201 can be powered to an active state sufficiently capable of handling the storage operations, as shown in step 610. For example, should one disc drive, such as the disc drive 403 from FIG. 4, suffice in handling the storage requirements needed by a user of data, then only one disc drive 403 need be “turned on” while the other disc drives 208 remain dormant to save power. A controller, such as the controller 504 from FIG. 5 or an individual magazine controller (a controller dedicated to each magazine 201), could manage the data storage operations. After performing and completing storage operations for the data consumer, step 612, the disc drive magazine 201 is caused to go into a dormant state which reduces power usage for the magazine 201, step 614.

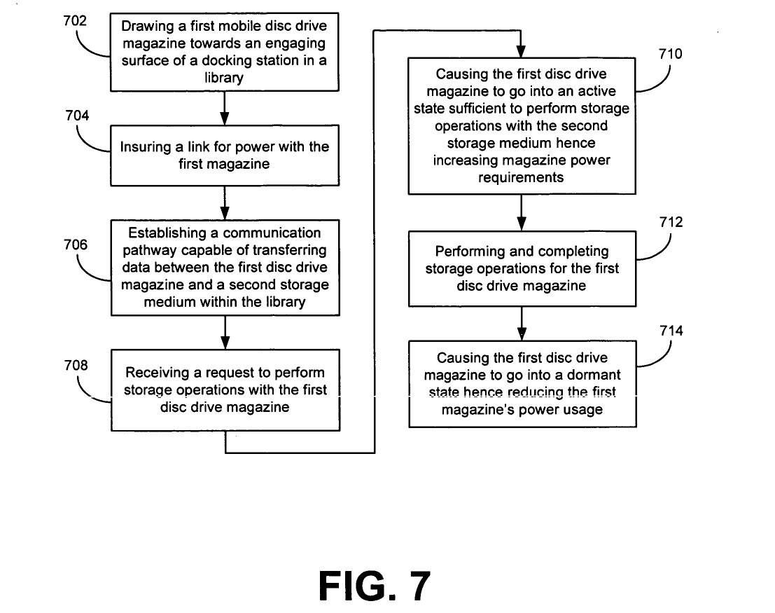

FIG. 7 shows another method to practice some embodiments of the present invention. Step 702, as shown by FIGS. 3A-3C, has a first disc drive magazine 201 being drawn towards an engaging surface of a docking station 202, such as surface 306 of FIG. 3A, of a library, such as the data storage library 100 of FIG. 1. Step 704 is a step for ensuring a link for power and communication between the mobile disc drive magazine 201 and the docking station 202. Step 706 is a step for establishing a communication pathway capable of transferring data between the first disc drive magazine 201 and a second storage medium within the library 100. A second storage medium can be another disc drive magazine 201, a tape medium, such as a cassette 116 of FIG. 1, or some other type of storage medium known to a skilled artisan. Step 710 is a step for causing the first disc drive magazine 201 to go into an active state sufficient to perform storage operations with the second storage medium hence increasing magazine power requirements. Step 712 is a performing and completing storage operations step for the first disc drive magazine 201. Step 714 is a step for causing the first disc drive magazine 201 to go into a dormant state hence reducing power consumption of the first magazine 201. The example disclosed in FIG. 7 is applicable to redundant data storage within a data storage library, such as the library 100 of FIG. 1.

Embodiments of the present invention can be practiced, for example, with an RXT T950 storage library 800 commercially available from Spectra Logic Corporation of Boulder, Colo. With reference to FIGS. 8, 9, and 10, an embodiment of a magazine-based T950 data cartridge library 800 is described. Generally, the library 800 is comprised of: (a) a frame 804 for supporting the other elements of the library 800; (b) an entry/exit port 806; (c) a shelf system 808; (d) of drives 908; (e) a magazine transport 1012; (f) a cartridge transport 1014; (g) a power supply system 906; (h) a control system 902; and (i) fans 820 for cooling the library.

The library 800 is illustratively adapted for operating with magnetic tape cartridges, such as the cartridges 116, and tape cartridge magazines, such as the tape cassette magazine 114 of FIG. 1, that contain the tape cartridges 116. Specifically, the library 800 is adapted for operating on cartridges 116 that conform to the following cartridge formats: (a) LTO (linear tape open), (b) SAIT (super advanced intelligent tape, and (c) DLT (digital linear tape). Typically, the library 800 is only used to store magazines that are each used to hold cartridges with the same cartridge format. For instance, the library 800 may be used to store magazines that are each used to hold LTO tape cartridges. However, the library 800 is capable of storing magazines that are used to hold cartridges of different types. For instance, the library 800 is capable of storing a magazine that holds LTO tape cartridges and another magazine that holds DLT tapes. Typically, each magazine used by the library 800 is only used to hold tape cartridges that conform to a single format. For instance, the library 800 may be used to store a magazine of LTO tape cartridges only. However, the library 800 is also capable of storing a magazine holding cartridges of different formats. For instance, the library 800 is capable of storing a magazine that is used to hold both LTO and SAIT tape cartridges.

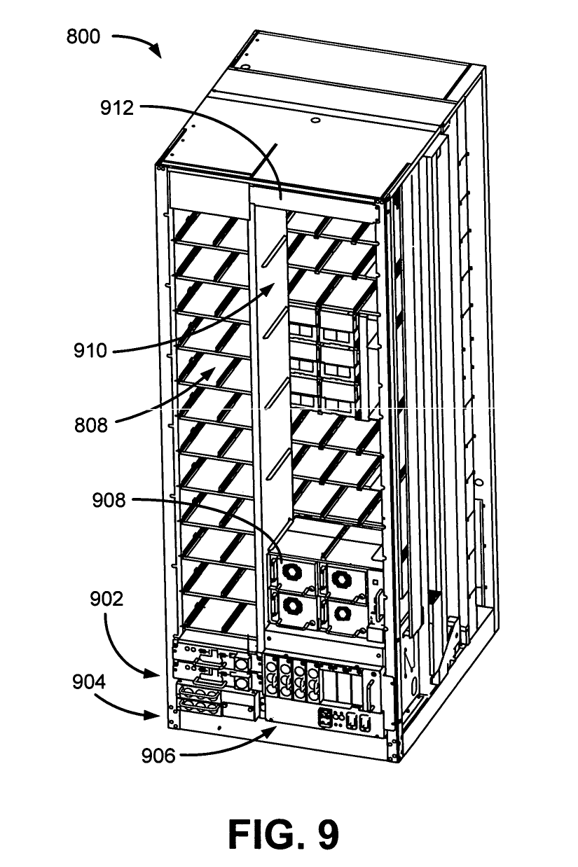

In addition to the general layout of the library 800, a user of the library 800 has a choice about the function of certain space in the library 800. To elaborate and with reference to FIG. 9, the library 800 illustratively comprises a user-definable space 910 with six stations that are each capable of accommodating either one of two types of modules. Each of the stations is capable of accommodating a drive bay module (i.e. functioning as a drive bay, as disclosed for FIG. 1) that holds up to four drives or docking stations, such as the docking station 202 of FIG. 2, or a magazine bay module that provides shelving for up to four magazines. Further, if multiple stations are employed, each station does not need to have the same dimensions. For instance, a station could accommodate either only one drive or provide shelving for only one magazine.

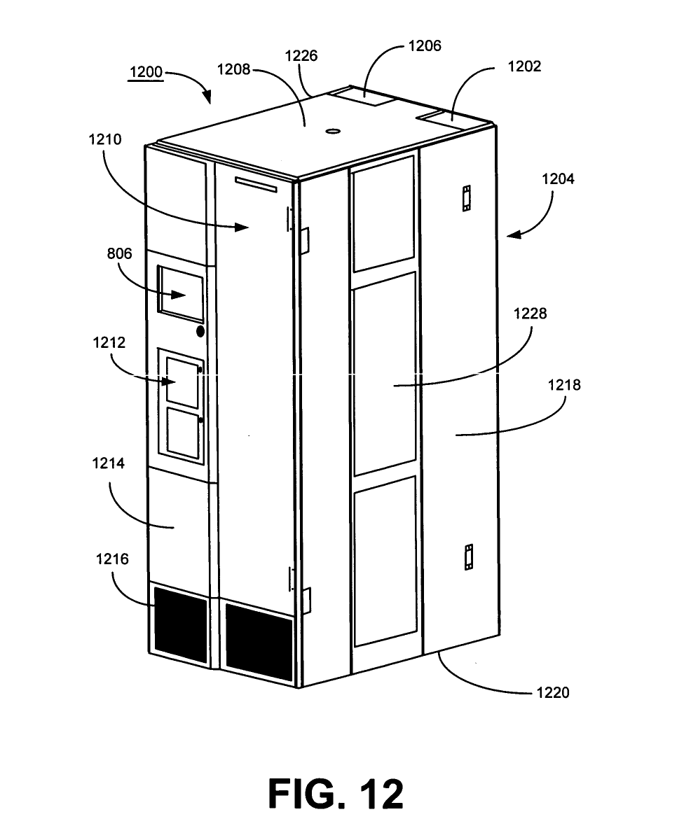

With reference to FIG. 12 as it relates to FIGS. 8-11, the frame 804 comprises elements that define the edges of a box-like structure and the surfaces of the box-like structure 1200. The surface of the box-like structure 1200 substantially encases the library 800 of in FIGS. 8-11. The front surface 1214 also comprises an operator interface that is implemented with a touch screen 1212, and a grill structure 1216 that covers the fans 820. The surface 1204 includes a fixed panel (not shown) that is located adjacent to a series of shelves, a hinged door panel (not shown) that provides access to the tape drives and docking stations 908 and the power supply 906, an opening (not shown) through which an AC cable(s) is/are connected to the power supply 906, and a grill (not shown) for promoting air circulation within the library 800. The front surface 1214 is removable so that the library 800 can be cascaded with at least one add-on unit to expand the library 800. Also associated with the first side surface 1218 is a first clear panel 1228 that allows an operator to view the interior of the library 800. The top surface 1208 of the library 800 includes a pair of knockouts 1206 and 1202 that can be used to receive one or more AC cables that are connected to the power supply 906 and/or one or more computer cables that are used to connect the library 800 to a host computer. Associated with the bottom surface 1220 are casters (not shown) that facilitate movement of the library 800 and adjustable stands (not shown) that allow the library 800 to be leveled after the library 800 has been positioned in a relatively permanent location. Further associated with the bottom surface 1220 are openings (not shown) for receiving one or more AC cables that are connected to the power supply 906 and/or a computer cable(s) that are used to connect the library 800 to a host computer.

Generally, the entry/exit port 806 serves to move magazines between: (a) an environment that is exterior to the library 800 and accessible to an operator; and (b) a space located within the library 800 and accessible by the magazine transport 1012. When the entry/exit port 806 is exposed to the exterior environment such that an operator can either remove a magazine that has been conveyed from the space within the library 800 or place a magazine in the entry/exit port 806 for conveyance to the space within the library 800, the port 806 is in a first state. Similarly, when the port 806 is exposed to the space located within the library 800 such that the magazine transport 1012 can either remove a magazine that is in the space or place a magazine in the space (typically, for conveyance to the exterior environment) the magazine is in a second state.

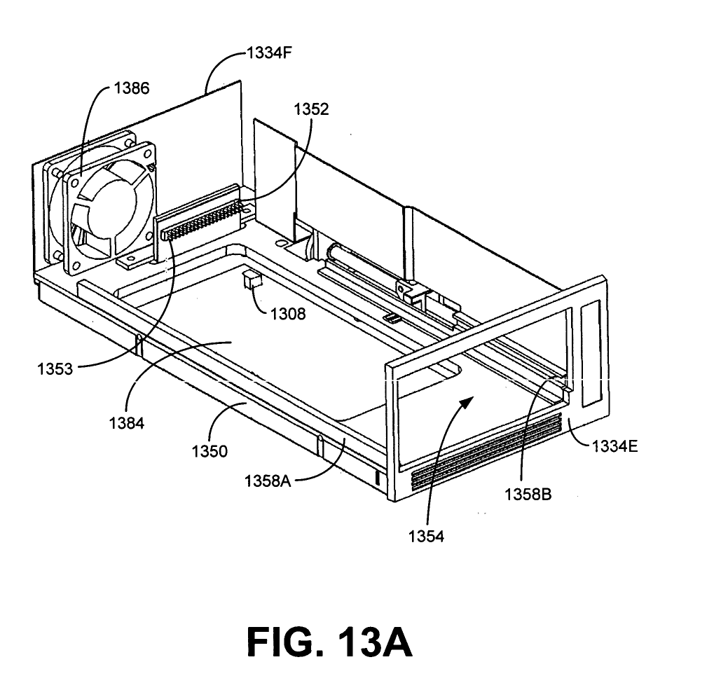

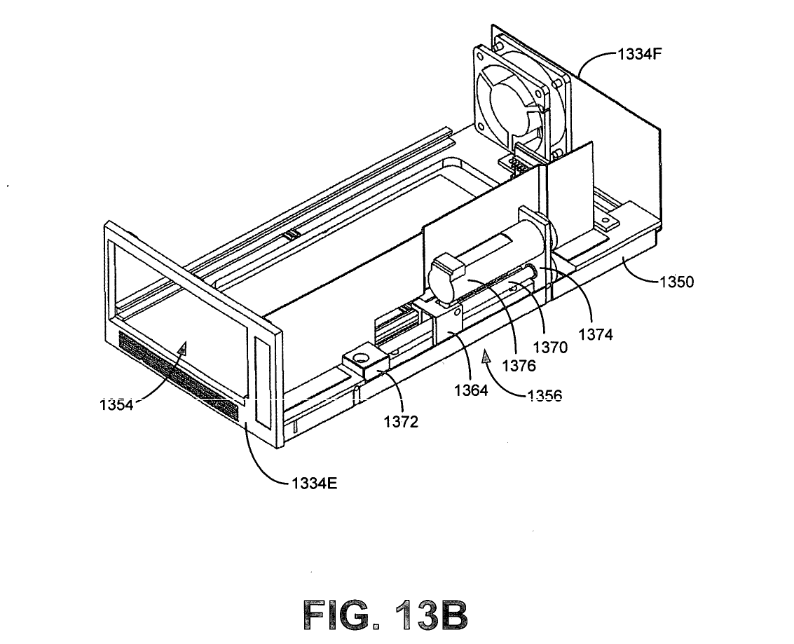

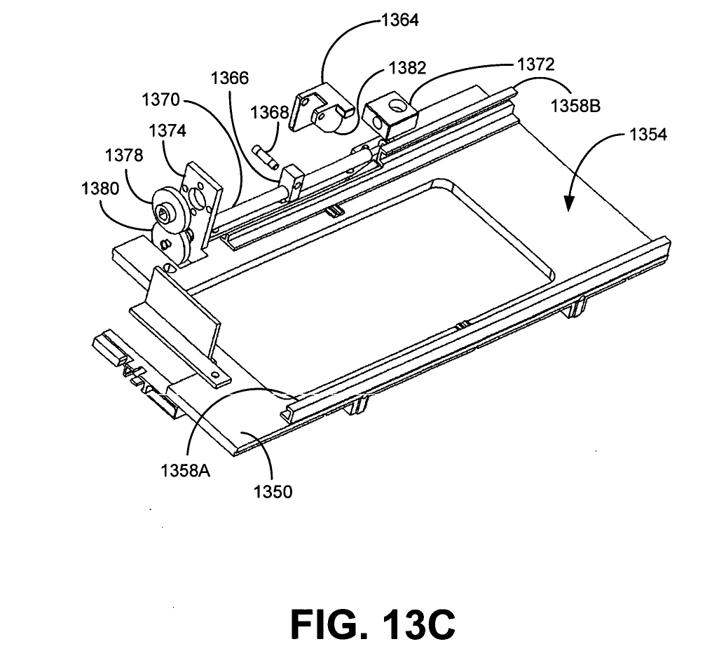

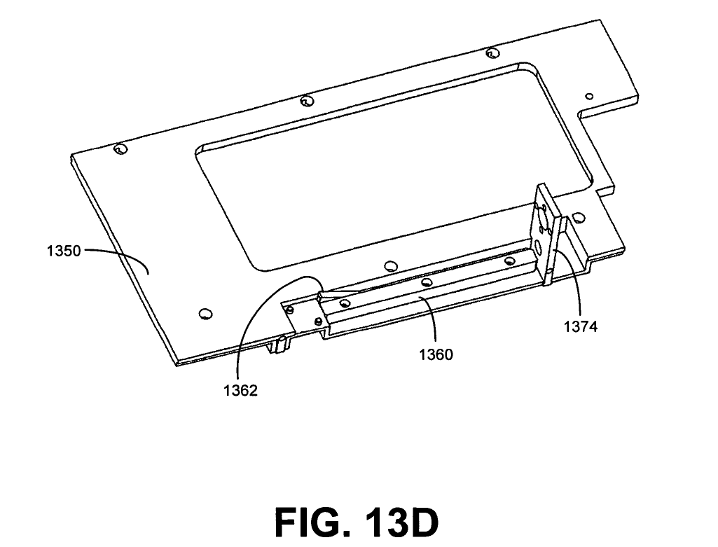

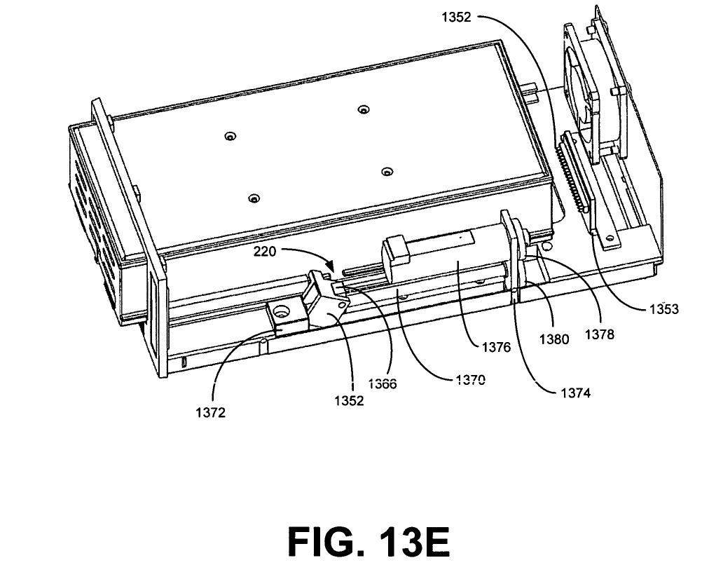

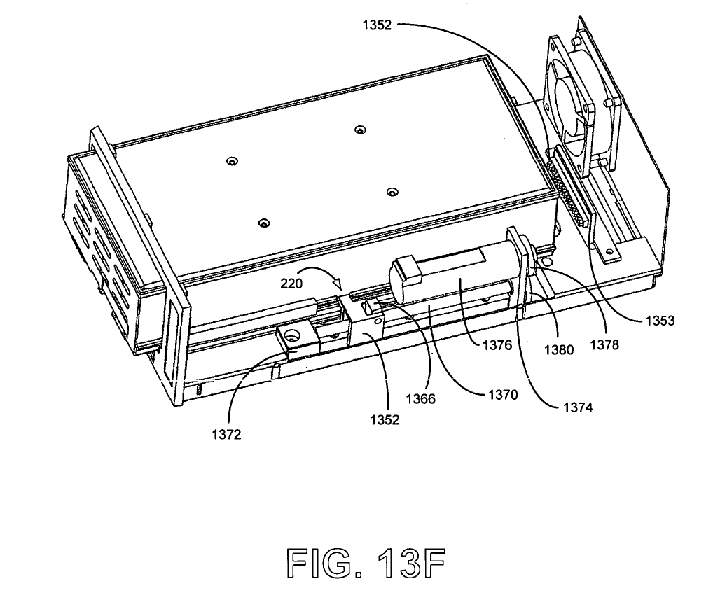

With reference to FIGS. 13A-13D, the docking station 202 of FIG. 2., is further comprised of a chassis 1350 that generally provides a mounting surface for other elements that comprise the docking station 202, such as a front wall 1334E and back wall 1334F for example. The chassis 1350 also provides a mounting surface for: (a) a drive-magazine connector 1352 that interfaces with the magazine-drive connector, such as the contact 305 from FIG. 3B, of the mobile disc drive magazine 201; (b) a magazine guide structure 1354 that cooperates with the rails (not shown) of the mobile disc drive magazine 201 to align the disc drive magazine contact 305 with the drive-magazine connector 1352; and (c) a magazine insertion/ejection system 1356 that is used to force the magazine contact 305 into engagement with the drive-magazine connector 1352 during an insertion operation and out of engagement with the drive-magazine connector 1352 during an ejection operation. Also attached to the chassis 1350 is a controller board 1384 that comprises electronic circuitry for controlling the operation of the drive relative to a magazine data storage element. In this regard the controller board 1384 provides the ability to manage or configure the hard disk drives associated a magazine data storage element. In one embodiment, the controller board 1384 is capable of configuring the hard disk drives as a redundant array of independent drives (RAID) or as just a bunch of drives (JBOD). A fan 1386 is attached to the docking station's 202 back wall 1334F and is used, during operation, to pull air across the controller board 1384 and through a mobile disc drive magazine 201, to cool the board and the hard disk drives 208 within the magazine 201.

The drive-magazine connector 1352 is comprised of a plurality of spring-loaded pins 1353. The free end of each of the pins is positioned to engage a corresponding conductive pad 305 associated with a magazine-drive connector 307 on the mobile disc drive magazine 201 when the magazine 201 is properly inserted into the docking station 202. Most, if not all, of the pins 1353 are connected to the plug interface (not shown) at the fixed end of the spring-loaded conductor pins 1353. If the magazine-drive connector 307 comprises optical pads/receivers instead of conductive pads 305, the drive-magazine connector 1352 employs an optical “pin” structure that is capable of engaging the optical receiver. It should be appreciated that the magazine connector region 307 may comprise one or more optical pads/receivers and one or more electrically conductive pads. In which case, the drive-magazine connector 1352 and the conductors 1353 are adapted accordingly. Spring-loaded pins 1353 are employed to reduce the occurrence of broken pins 1353 that could disable the magazine 201. Further, the use of spring loaded pins 1353 and pads 305 to establish a connection between a magazine 201 and the docking station 202 allows some alignment tolerance relative to a male/females connection structure, i.e., the magazine-drive connector 307 of a magazine 201 does not need to be as accurately aligned to engage the drive-magazine connector 1352 as would be the case if the magazine-drive connector 1314 employed a plurality of female sockets. It should be appreciated that the drive-magazine connector 307 can, in an alternative embodiment, comprise a plurality of pads 305 that interface with a magazine-drive connector 307 that is comprised of a plurality of pins, such as the pins 1353 (i.e. a reversed pin 1353/pad 305 geometry). Other types of connection interfaces are feasible. For instance, a male/female connection interface is feasible. However, as previously noted, such an interface is likely to have more pin breakages and tighter alignment tolerances.

The magazine guide structure 1354 is comprised of first and second guide rails 1358A, 1358B that cooperate with the rails (not shown) of the magazine 201 to assure that the magazine 201 is oriented so that the magazine-drive connector 307 appropriately interfaces with the drive-magazine connector 1352.

The magazine insertion/ejection system 1356 is comprised of: (a) a cam plate 1360; (b) a cam ramp 1362; (c) a cam hook 1364; (d) a lead screw nut 1366; (e) a pin 1368 that pivotally attaches the cam hook 1364 to the lead screw nut 1366; (f) a lead screw 1370 that receives the lead screw nut 1366; (g) a lead screw mounting block 1372 that provides a bearing mount for one end of the lead screw 1370; (h) a lead screw and motor mounting block 1374 that provides a bearing mount for the other end of the lead screw 1370 and a mount for a DC motor; (i) a DC motor 1376 for providing the rotational motive force that is used to move the lead screw nut 1366 back and forth along the lead screw 1370; (j) a pinion 1378 that is operatively attached to the drive shaft of the DC motor 1376; and (k) a gear 1380 that is attached to the lead screw 1370 and cooperates with the pinion 1378 to transmit the rotational motive force produced by the DC motor to the lead screw 1370.

In operation, the magazine insertion/ejection system 1356 is either in a disengaged state or an engaged state. FIG. 13E illustrates the disengaged state of the magazine insertion/ejection system 1356. In the disengaged state, the cam hook 1364 is positioned so as not to be able to engage the notch 220 associated with the mobile disc drive magazine 201. This positioning of the cam hook 1364 is achieved by using the DC motor 1376 to drive the lead screw nut 1366 and the cam hook 1364 towards the lead screw mounting block 1372. As the lead screw nut 1366 and cam hook 1364 approach the lead screw mounting block 1372, a surface 1382 of the cam hook 1364 engages the cam ramp 1362. As the lead screw nut 1366 is driven further towards the lead screw mounting block 1372, the cam ramp 1362 applies a force to the cam hook 1364 via the surface 1382 that causes the cam hook 1364 to rotate to a position at which the cam hook 1364 is not able to engage the notch 220.

FIG. 13F illustrates the engaged state of the system 1356. In the engaged state, the cam hook 1364 is positioned to engage the notch 220 associated with the magazine 201. This positioning of the cam hook 1364 is achieved by using the DC motor 1376 to drive the lead screw nut 1366 and the cam hook 1346 to a position at which the surface 1382 of the cam hook 1364 is immediately adjacent to, but not engaging the cam ramp 1362. Once the cam hook 1364 has engaged the notch 220, movement of the cam hook 1364 between the start of the cam ramp 1362 and the lead screw/motor mounting block 1374 is used to apply either a force that drives the magazine 201 towards the drive-magazine connector 1352 or a force that drives the magazine away from the drive-magazine connector 1352.

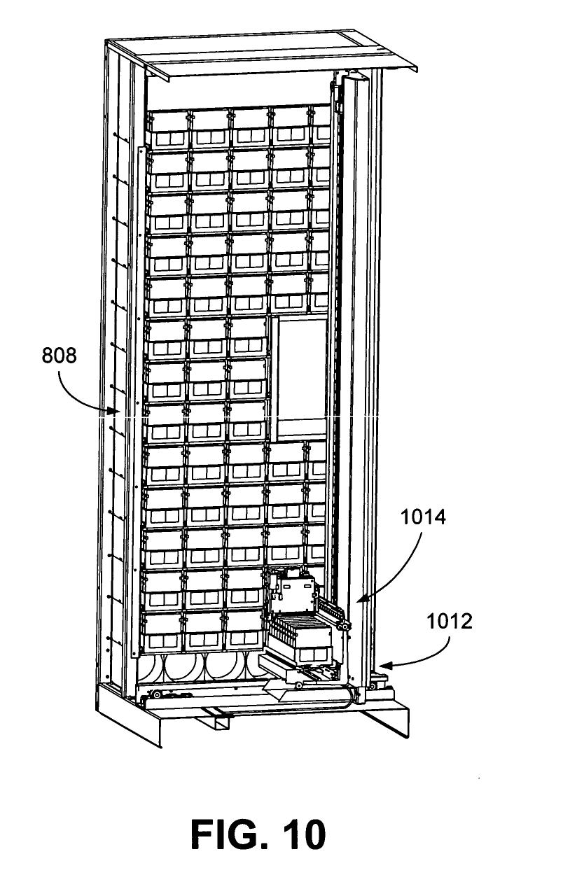

The manner in which the mobile disc drive magazine 201 is moved within the library 800 is substantially identical to the manner in which a data cartridge magazine, such as the tape cassette magazine 114 of FIG. 1, is moved within the library 800, i.e. via the transport unit 1012 of FIG. 10. Furthermore, the mobile disc drive magazine 201 can be moved into and out of the library 800 via the entry/exit port 806 of FIG. 8, which is also substantially identical to the manner in which the data cartridge magazine 114 is moved into and out of the library 800. Likewise, the manner in which the mobile disc drive magazine 201 is moved away from a shelf 808 of FIG. 8 and towards a shelf 808 is via the transport unit 1012, which is also substantially identical to the manner in which the tape cassette magazine 114 is moved towards and away from a shelf 808.

Some power reduction embodiments of the present invention can be commercially practiced with an RXT disc drive magazine 201, which can include options of various levels of quiescence including normal, idle, standby and sleep mode. A disc drive 208 can be controlled to function in a fully powered, or normal state, wherein power can be consumed to operate a fully spinning disc 211 and actuating heads 209, for example. In an idle state, the heads 209 as shown in FIG. 2, can be “parked”, such as at the outer diameter of a disc 211 near a load/unload zone (not shown) typically used with a mobile disc drive for example, affording a slight reduction in power consumption by the disc drives 208. A standby mode offers greater power reduction whereby the heads 209 of the disc drive 208 might be parked and the discs 211 spun at a lower RPM. A sleep mode offers the greatest reduction in power of these example modes because in this mode, the heads 209 are parked and the discs 211 are not spinning; only the logic chips remain powered.

In one embodiment, the RXT disc drive magazine 201 is adapted to control power to the disc drives 208, and hence, the independent controller capabilities of the magazine 201 can completely power off one or more of the disc drives 208. This mode might be called a Deep Sleep mode, and can be used if a drive 208 has failed and is no longer part of the RAID set comprised by a magazine 201 or is a hot space which acts as a redundant drive in the RXT pack, for example.

Some embodiments for controlling alternate power modes for disc drives 208 comprised by an RXT disc drive magazine 201 may include disc drive inactivity timers, controller inactivity timers, host software inactivity timers or simply user controlled power modes, just to name of few. In more detail, disc drives 208 themselves can be programmed to enter successively deeper modes of inactivity depending on elapsed time of inactivity. For example, disc drives 208 can be programmed to enter an Idle mode after 10 minutes of inactivity, Standby mode after 20 minutes of inactivity, and Sleep mode after 30 minutes of inactivity, for example. The disc drives 208 can be linked together in the disc drive magazine 201 whereby one disc drive 208 can control the other disc drives 208 in a master/slave relationship. Alternatively, the disc drives 208 can be linked to influence each other independently as the need may arise, such as engaging in RAID striping or backup operations with one or more other drives 208, for example. In another embodiment, an RXT disc drive magazine 201 can include controller capabilities adapted to control the activity of the disc drives 208 collectively or individually.

In yet another embodiment of the present invention, host operated software can control the level of inactivity in an RXT disc drive magazine 201. For example, host operated software can control backup storage operations. In this example, the host, such as the host computer 102, may backup data in the T950 library 800 at specific time intervals, such as every evening at 8:00 pm for example. Hence, the host computer 102 can command the RXT disc drive magazine 201 to be in a dormant state, or one of many low power modes, between backup operations via SCSI, ISCSI, Fiber or other host interface using a vendor unique command or diagnostic.

In yet another embodiment of the present invention, a user can control the level of inactivity in an RXT disc drive magazine 201. A user can command various power modes for the disc drives 201 through at least one of several interfaces, such as a direct Ethernet connection to the RXT docking station 202 and magazine 201 and using an RXT 202 web server or through the library's 800 touch screen 1212 that is linked with the RXT's docking station 202 through the DCM/s (Drive Control Module) via CAN (Controller Area Network), to the RXT docking station 202 via an RS-422 connection between the DCM and RXT docking station 202.

It is to be understood that even though numerous characteristics and advantages of various embodiments of the present invention have been set forth in the foregoing description, together with the details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, numerous time accounting techniques (clocks, timers, etc.) can be used to monitor elapsed time of inactivity for a disc drive magazine, such as the RXT disc drive magazine 201 of FIG. 2, for use with various dormant modes of the magazine 201 while still maintaining substantially the same functionality without departing from the scope and spirit of the present invention. Another example can include setting a time limit of inactivity regarding storage operations which can vary depending on user needs or equipment limitations, just to name a few examples while still maintaining substantially the same functionality without departing from the scope and spirit of the present invention. Further, though communication is described herein as between a host computer 102 and the docking station 202, communication can be received by the data storage library 100 and channeled to a docking station 202 without departing from the scope and spirit of the present invention. Finally, although the preferred embodiments described herein are directed to disc drive systems, such as the disc drive magazine 201, and related technology, it will be appreciated by those skilled in the art that the teachings of the present invention can be applied to other systems, without departing from the spirit and scope of the present invention.

It will be clear that the present invention is well adapted to attain the ends and advantages mentioned as well as those inherent therein. While presently preferred embodiments have been described for purposes of this disclosure, numerous changes may be made which readily suggest themselves to those skilled in the art and which are encompassed in the spirit of the invention disclosed and as defined in the appended claims.

What is claimed is:

1. A data storage library comprising:
at least one of a plurality of docking stations adapted to receive a disc drive magazine wherein the magazine comprises a plurality of disc drives;
a loading device adapted to automatically engage the magazine with the at least one docking station to establish a communication link between the magazine and the at least one docking station;
a retaining device adapted to retain the magazine when engaged with the at least one docking station and when the magazine is in at least an active state;
at least one interface adapted to establish a communication link capable of transferring data between at least one data consumer and the library;
the magazine capable of storing data received by the at least one data consumer when linked with the at least one docking station;
the magazine capable of changing from a fully active state to at least one quiescent state when storage operations performed by the magazine requires less than a fully active magazine.

2. The data storage library of claim 1 wherein the plurality of disc drives is substantially encased in the magazine by an enclosure.

3. The data storage library of claim 1 wherein the loading device is adapted to pull the magazine into the at least one docking station to engage the magazine with the at least one docking station and eject the magazine to disengage the magazine from the at least one docking station.

4. The data storage library of claim 3 wherein the loading device is disposed in the docking station.

5. The data storage library of claim 1 further comprising a sensing system for the retaining device wherein the sensor is adapted to monitor when the magazine is engaged and active with the at least one docking station.

6. The data storage library of claim 5 further comprising an eject switch is adapted to cause the magazine to be ejected from the at least one docking station when the sensing system determines the magazine substantially inactive.

7. The data storage library of claim 1 wherein the at least one quiescent state is a state wherein less than all of the disc drives are dormant in the magazine.

8. The data storage library of claim 1 wherein the at least one quiescent state is a state wherein all of the disc drives are dormant and the magazine is in substantially an inactive state.

9. The data storage library of claim 1 further comprising a plurality of tape cassettes and at least one tape drive capable of storing data on the tape cassettes.

10. The data storage library of claim 9 further comprising a robotic system adapted to transport at least one of the tape cassettes supported by a shelving system substantially in the library to the at least one tape drive or the magazine supported by the shelving system to the at least one docking station.

11. The data storage library of claim 10 wherein the shelving system is capable of supporting a second and third disc drive magazine.

12. A data storage library comprising:
at least one of a plurality of docking stations adapted to receive a mobile disc drive magazine wherein the magazine comprises a plurality of disc drives;
a loading device adapted to automatically pull the magazine into the at least one docking station in an engaging relationship to establish a communication link between the magazine and the at least one docking station and wherein the loading device is also adapted to automatically eject the magazine in a disengaged relationship with the at least one docking station when the magazine is in a substantially inactive state;
an interface adapted to establish a communication pathway capable of transferring data between at least one data consumer and the library;
the magazine capable of storing data received by the at least one data consumer when linked with the at least one docking station;
the magazine capable of changing from a fully active state to at least one quiescent state when storage operations performed by the magazine requires less than a fully active magazine.

13. The data storage library of claim 12 wherein the loading device is further adapted to retain the magazine in an engaging relationship with the at least one docking station prior to ejecting the magazine.

14. The data storage library of claim 12 wherein the quiescent state is a state wherein less than all of the disc drives are dormant in the magazine.

15. The data storage library of claim 12 wherein the quiescent state is a state wherein all of the disc drives are dormant.

16. The data storage library of claim 12 wherein the quiescent state of the magazine is controlled by one of the group consisting of: a controller comprised by the library, a controller comprised by the docking station, a controller comprised by the magazine, an algorithm comprised by the library, an algorithm comprised by the magazine, the at least one host.

17. A system for saving power in a data storage library comprising:
means for automatically drawing a mobile disc drive magazine towards a connecting surface of one of a plurality of docking stations comprised by the library;
means for engaging the magazine with the docking station in an operatively linked state capable of storing data;
means for establishing a communication pathway capable of transferring data between a data consumer and the library;
means for retaining the magazine and the docking station in the operatively linked state while the magazine is actively engaged in storage related operations;
means for changing the magazine from an active state to a quiescent state when the storage operations requires less than a fully active magazine.

18. The system of claim 17 further comprising means for moving the magazine from a storage location within the library to the docking station.

19. The system of claim 18 wherein the means for moving the magazine is accomplished with a robotic transport system and media picker.

20. The system of claim 17 further comprising means for automatically ejecting the magazine to establish an unlinked and unengaged state in relation to the docking station when the magazine is in a substantially inactive state.

21. A data storage library comprising:
at least one of a plurality of docking stations adapted to receive a disc drive magazine to establish a communication link between the magazine and the at least one docking station wherein the magazine comprises a plurality of disc drives;
a retaining device adapted to retain the magazine when engaged with the at least one docking station and when the magazine is in at least an active state;
at least one interface adapted to establish a communication link capable of transferring data between at least one data consumer and the library;
the magazine capable of storing data received by the at least one data consumer when linked with the at least one docking station;
the magazine capable of changing from a fully active state to at least one quiescent state when storage operations performed by the magazine requires less than a fully active magazine.
